(19) United States
(12) Patent Application Publication
(10) Pub. No.: US 2019/0330971 A1
(43) Pub. Date: Oct. 31, 2019

(54) ELECTRICAL SUBMERSIBLE PUMP WITH A FLOWMETER

(71) Applicant: Saudi Arabian Oil Company, Dhahran (SA)

(72) Inventors: JINJIANG XIAO, DHAHRAN (SA); CHIDIRIM ENOCH EJIM, DAMMAM (SA)

(73) Assignee: Saudi Arabian Oil Company, Dhahran (SA)

(21) Appl. No.: 15/965,409

(22) Filed: Apr. 27, 2018

(51) Int. Cl. E21B 47/00; E21B 47/06; E21B 43/12; G01F 1/74; G01F 1/44; F04D 15/00; F04D 13/10

(52) U.S. Cl. CPC E21B 47/0007; E21B 47/06; E21B 43/128; F04D 13/10; G01F 1/44; F04D 15/0066; G01F 1/74

(57) ABSTRACT

A system and method for metering fluid being handled by an electric submersible pump that is disposed in a wellbore. The system includes a tubular member with an axial bore through which the fluid is directed. A restriction in the bore creates a temporary pressure drop in the fluid. The pressure drops from the restriction and losses in a portion of the tubular member having a constant cross sectional flow area, and which are measured by pressure taps. A flowrate of the fluid is estimated based on the measured pressure drops, expressions representing pressure changes due to static head and dynamic pressure losses in the constant cross sectional flow area and conservation of mass and/or energy across the restriction.

### BACKGROUND

### 1. Field

The present disclosure relates to electrical submersible pumps fitted with a flowmeter. More specifically, the disclosure relates to electrical submersible pumps with a flowmeter having a venturi and differential pressure sensors.

### 2. Related Art

Electrical submersible pumping (“ESP”) systems are deployed in some hydrocarbon producing wellbores to provide artificial lift to deliver fluids to the surface. ESP systems are also sometimes used to transfer fluids from a wellsite to other equipment or facility for further processing. The fluids are usually made up of hydrocarbon and water. When installed, a typical ESP system is suspended in the wellbore at the bottom of a string of production tubing. Sometimes, ESP systems are inserted directly into the production tubing. In addition to a pump, ESP systems usually include an electrically powered motor for driving the pump, and a seal section for equalizing pressure in the motor to ambient pressure. Centrifugal pumps usually have a stack of alternating impellers and diffusers coaxially arranged in a housing along a length of the pump. The impellers each attach to a shaft that couples to the motor, rotating the shaft and impellers force fluid through passages that helically wind through the stack of impellers and diffusers. The produced fluid is pressurized as it is forced through the helical path in the pump. The pressurized fluid is discharged from the pump and into the production tubing, where the fluid is then conveyed to surface for processing and distribution downstream.

Often, water is included with the produced fluid, and which is separated from the produced fluid either downhole or on surface. Usually the separated water is injected back into the formation, where it can be used to pressure balance the reservoir or formation. Flowmeters are often used in conjunction with ESP systems for measuring the quantity of fluid produced by the well. The presence of water in the produced fluid complicates estimates of how much hydrocarbon is produced. Moreover, further complications arise when the produced fluid reaches surface at less than bubble point pressure as flowmeters at surface are typically designed to measure single phase flow rather than two phase (gas/liquid) flow. While multiphase flowmeters are available, they are appreciably more expensive than single phase flowmeters.

### SUMMARY

Disclosed is an example of a method of estimating a characteristic of a fluid being handled by an electrical submersible pump disposed in a wellbore. The example method includes directing the fluid through an axial bore in a tubular member, obtaining a pressure of the fluid at a first location in the tubular member, obtaining a pressure of the fluid at a second location in the tubular member that is downstream of the first location, obtaining a pressure of the fluid at a third location in the tubular member that is downstream of the second location. At the third location is where a cross section of the bore is reduced to define a restriction. The method further includes estimating a flowrate of the fluid in the tubular member based on values of pressures at the first, second, and third locations. Estimating the flowrate of the fluid also includes using an expression representing a change in static head, an expression representing pressure losses due to friction between the first and second locations, and an expression representing fluid flowrate based on conservation of mass and/or energy of the fluid flowing across the restriction. In an alternative, the restriction is a venturi meter. In one example, the expression representing the change in static head is (g)*(Y₁)*(μₘ), and where g=gravitational acceleration, Y₁=a change in elevation between the first and second pressure measurement locations, and ρₘ=density of the fluid in the tubular member. In one alternative, the expression representing pressure losses due to friction between the first and second pressure measurement locations is 8(f)*(L₁)*(ρₘ)*(Qₘ²)/((π²)*D⁵)), and where f=frictional factor, L₁=a distance between the first and second locations, Qₘ=the flowrate of the fluid flowing in the tubular member, D=diameter of the tubular between the first and second locations. In another example, the expression representing fluid flowrate based on conservation of mass and/or energy of the fluid flowing across the restriction is Qₘ=C(((ΔP₂−(g)*(μₘ)*(L₂))/(μₘ))^{1/2}, and where C=a coefficient for the restriction, ΔP₂=measured pressure drop between the second and third locations, L₂=distance between the second and third pressure measurement locations. The method further optionally includes estimating oil and water fractions of the fluid. In an embodiment, the tubular is disposed adjacent the electrical submersible pump. Embodiments exist where the restriction is a venturi meter having a length that ranges from about 27 to about 38 times a diameter of the bore.

Also disclosed is a method of estimating a characteristic of a fluid being handled by an electrical submersible pump disposed in a wellbore. The method of this example includes obtaining a first pressure of the fluid at a first location in a tubular member in which the fluid is flowing, obtaining a second pressure of the fluid at a second location in the tubular member and that is downstream of the first location, and obtaining a third pressure of the fluid as the fluid flows across a restriction. A flowrate of the fluid is estimated based on changes in static head between the first and second locations and a change in pressure between the second and third locations. The restriction optionally is a throat of a venturi meter and the second location is at an entrance to the venturi meter. In one example the fluid is a mixture of water and oil, and where a density of the fluid is estimated in conjunction with the step of estimating the flowrate. The method optionally includes adjusting an operating parameter of the electrical submersible pump based on the estimated flowrate.

Also disclosed is an example of electrical submersible pumping system disposed in a wellbore and which includes a pump section having an inlet, a motor section for driving the pump section, a seal section coupled with the motor section, ESP monitoring sub, and a meter that estimates a characteristic of a fluid handled by the electrical submersible pump. The meter of this example includes a tubular member having a bore extending axially within, a restriction in a portion of the bore, a first pressure tap in the tubular member, a second pressure tap in the tubular member that is downstream of the first pressure tap and disposed at an entrance to the restriction, and a third pressure tap in the tubular member and disposed at the restriction. Alternatively included is a controller that is in communication with sensors that are in communication with the first, second, third pressure taps, the controller configured to estimate a flowrate of the fluid based on pressures measured at the pressure taps. The restriction optionally is a throat portion of a venturi meter. The system optionally includes a caisson circumscribing the motor section, seal section, ESP monitoring sub, and pump section to define a plenum space. In an example, fluid flows into the plenum space through a tubular element that extends through a portion of the caisson. Communication between the controller and sensors alternatively occurs along a power cable that connects to the motor section. Example locations of the meter include upstream of the pump inlet, and downstream of the pump inlet.

### BRIEF DESCRIPTION OF DRAWINGS

Some of the features and benefits of the present disclosure having been stated, and others will become apparent as the description proceeds when taken in conjunction with the accompanying drawings, in which:

FIG. 1 is an elevational view of an electrical submersible pump and an example of a flowmeter upstream of the electrical submersible pump.

FIG. 2 is an elevational view of an electrical submersible pump and an example of a flowmeter in a discharge line of the electrical submersible pump.

FIG. 3 is an elevational view of the electrical submersible pump and flowmeter of FIG. 1 and having a caisson circumscribing the electrical submersible pump.

FIG. 4 is an elevational view of the electrical submersible pump and flowmeter of FIG. 2 and having a caisson circumscribing the electrical submersible pump.

### DETAILED DESCRIPTION

The method and system of the present disclosure will now be described more fully after with reference to the accompanying drawings in which embodiments are shown. The method and system of the present disclosure may be in many different forms and should not be construed as limited to the illustrated embodiments set forth; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment, usage of the term “substantially” includes +/−5% of the cited magnitude.

It is to be further understood that the scope of the present disclosure is not limited to the exact details of construction, operation, materials, or embodiments shown and described. Modifications and equivalents will be apparent to one skilled in the art. Illustrative examples have been disclosed in the drawings and specification. Although specific terms are employed they are used in a generic and descriptive sense only and not for the purpose of limitation.

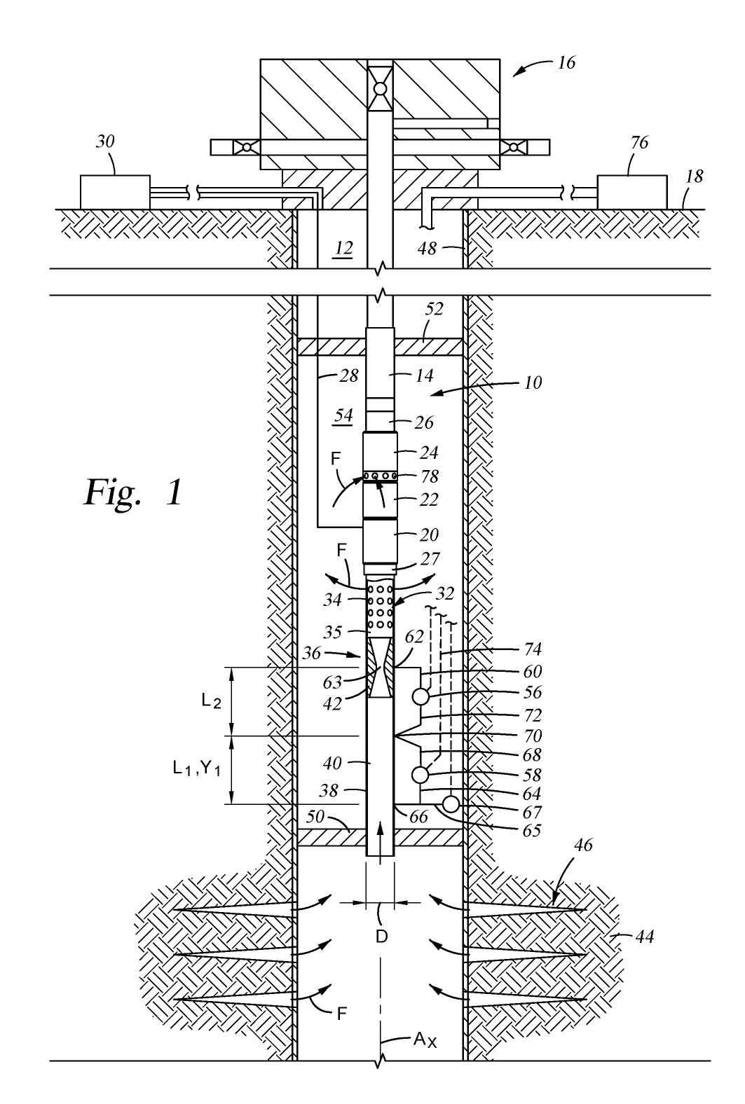

Shown in a side partial sectional elevational view in FIG. 1 is an example of an electrical submersible pumping (“ESP”) assembly 10 disposed in a wellbore 12. The ESP assembly 10 is deployed within wellbore 12 on production tubing 14. An upper end of the production tubing 14 hangs from a wellhead assembly 16 shown mounted on surface 18 and over the opening of wellbore 12. ESP assembly 10 includes a motor section 20, a seal section 22 adjacent motor section 20, and a pump section 24 mounted on a side of seal section 22 opposite from motor section 20. In one example, energizing motor section 20 drives impellers (not shown) disposed within pump section 24 and for pressurizing fluid for entry into production tubing 14. An optional auto flow sub 26 is shown coupled on an end of pump section 24 opposite from seal section 22. In an example, auto-flow sub 26 bypasses free-flow production around pump section 24 when pump section 24 is shutdown; when the pump is operating auto-flow sub 26 enables flow through the pump. Optionally included with the ESP assembly 10 is an ESP monitoring sub 27, that in an embodiment monitors downhole pressure(s), temperatures of motor oil and windings, ESP vibration, etc., and conveys the monitored information to surface 18. A power cable 28 is illustrated having an end connected to motor section 20 and an opposite end connected to a power supply 30 shown on surface 18. A variable speed drive (not shown) is optionally included with power supply 30. Power cable 28 carries electricity for powering motor section 20, and in an alternative provides a means for communication transfer between downhole and surface 18.

A distributor 32 with exit ports 34 formed radially through its sidewalls is shown in the example of FIG. 1, and which is coupled to an end of ESP assembly 10. Distributor 32 is a generally tubular member and having a bore 35 along its axis; and in one embodiment is made up of a pup joint. An example of a metering assembly 36 is illustrated on an end of distributor 32 opposite from ESP assembly 10. The example metering assembly 36 includes a conduit 38 having a bore 40 extending axially through the entire length of conduit 38 and which is in fluid communication with bore 35 of distributor 32. A portion of the conduit 38 includes a restriction 42 that reduces the cross sectional area of the conduit 38 in that region. Examples of the restriction 42 include any device with an opening or cross sectional area that is less than the cross sectional area of bore 40, such as but not limited to a venturi meter or orifice. In a further example where the restriction 42 is a venturi meter, the venturi meter has a length that ranges from about 27 to about 38 times a diameter of the bore 40 of the conduit 38. Optional embodiments exist where the restriction 42 is disposed separate from the conduit 38, an alternative example to this embodiment the restriction 42 is coupled with the conduit 38.

In the illustrated example, fluid F from formation 44 is channeled into wellbore 12 from perforations 46 extending from wellbore 12 into formation 44. More specifically, perforations 46 project radially outward from wellbore 12, through casing 48 that lines the wellbore 12, and into formation 44. Perforations 46 provide a pathway for fluid F within formation 44 to be routed to wellbore 12 and to be produced by ESP assembly 10. A first packer 50 is shown in an annular space between the outer surface of conduit 38 and inner surface of casing 48. An upper packer 52 is illustrated in the example which extends radially outward from an outer surface of production tubing 14 and axially away from motor section 24 on a side distal from distributer 32. First packer 50 and second packer 52 respectively fill the annular spaces between conduit 38 and casing 48 and tubing 14 and casing 48, and each define a flow barrier. Further, the combination of the ESP assembly 10 and first and second packers 50, 52 define an annulus 54 within wellbore 12. The presence of first packer 50 directs a flow of fluid F into bore 40 of the conduit 38. Continued flow of fluid F within bore 40 takes fluid F across restriction 42, and then to distributor 32 where the fluid F discharges into annulus 54 from exit ports 34.

Still referring to the example illustrated in FIG. 1, included with metering assembly 36 are pressure sensors 56, 58, where pressure sensor 56 is shown in pressure communication with restriction 42 via a sensor tube 60. An end of sensor tube 60 distal from pressure sensor 56 engages a pressure tap 62 formed radially through a side wall of conduit 38. More specifically, pressure tap 62 is aligned with a throat 63 within the restriction 42, which is a minimum diameter portion of restriction 42. Further in this example, pressure sensor 58 is in pressure communication with bore 40 via a sensor tube 64 shown connected on one end to pressure sensor 58, and on an opposite end to sensor tube 65. An end of sensor tube connects to pressure tap 66 shown projecting radially through the side wall of conduit 38 at a location between restriction 42 and first packer 50. An end of sensor tube 65 connects to sensor 67, which in this example senses pressure at an inlet to metering assembly 36. Another sensor tube 68 connects to pressure sensor 58 and also is in pressure communication with bore 40 via a pressure tap 70 that is formed in the side wall of conduit 38. Pressure tap 70 is shown disposed between pressure tap 66 and restriction 42. In the illustrated embodiment, pressure tap 66 and pressure tap 70 are located in a portion of conduit 38 having a substantially constant inner diameter D. Sensor tube 68 is shown providing pressure communication between pressure sensor 58 and sensor tap 70. In the example of FIG. 1, pressure sensor 56 selectively measures a pressure differential within conduit 38 and between a location of pressure tap 70 and throat 63 of the restriction 42. Pressure sensor 58 in this example selectively measures a pressure differential within conduit 38 and between the locations of pressure taps 66, 70. The pressure sensors 56, 58 are optionally connected directly to the sensor/monitoring sub 27 and the data transmitted by the power cable 28 to the surface 18, such as in current ESP installations. In one alternate embodiment, communication means 74 are shown that provide communication between the pressure sensors 56, 58, 67 and a controller 76 shown on surface 18. Examples of communication means 74 include hardware, wireless, fiber optics, and the like. The communication means 74 in an embodiment extends along production tubing 14 to surface 18. Alternatively, communication means 74 is incorporated within the power cable 28. Inlet ports 78 are illustrated on pump section 24, and through which fluid F flows into pump section 24.

In an alternative, the metering assembly 36 is integrated into the existing ESP assembly 10. In this example, information from one or more of pressure sensors 56, 58, 67 is in selective communication to the ESP monitoring sub 27. In one example embodiment, information communicated to sensor/monitoring sub 27 from sensors 56, 58, 67 is communicated to surface 18 via the power cable 28, such as in existing ESP applications. In one embodiment, communicating via the power cable 28 removes the need for multiple cables in the wellbore 12, as well as the need for controller 76. In an alternative, controller 76 is integrated with ESP monitoring sub 27, power supply 30, or both.

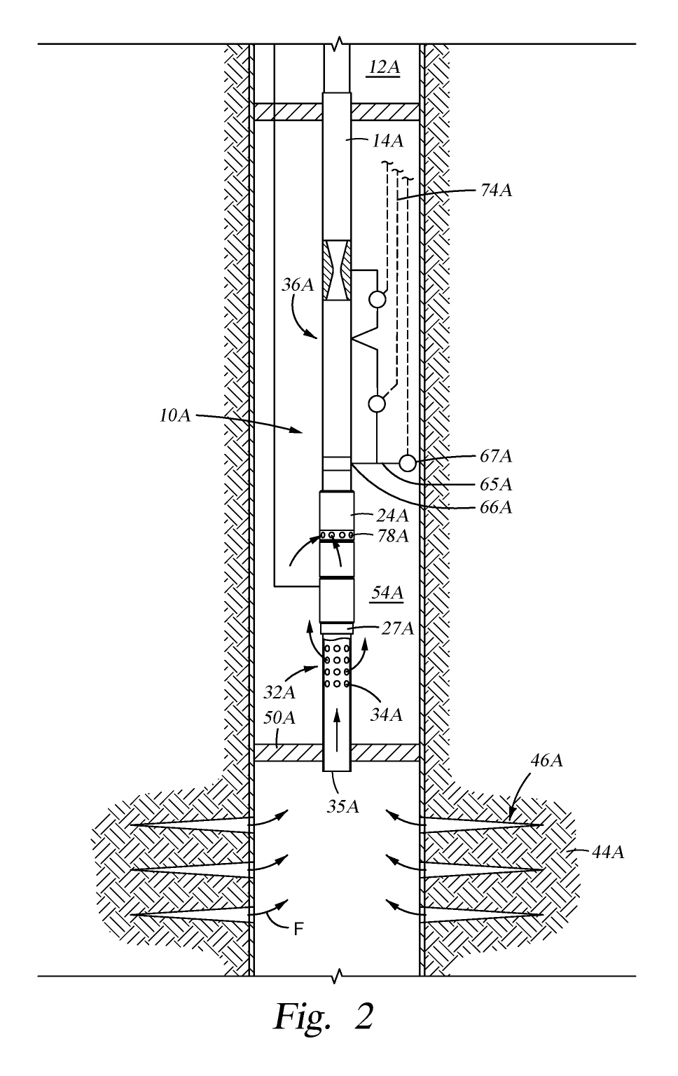

Shown in a side partial sectional plan view in FIG. 2 is one alternate example of an ESP assembly 10A. In this example, the metering assembly 36A is disposed within production tubing 14A and downstream of the pump section 24A. In this embodiment distributor 32A is upstream of ESP assembly 10A and set within packer 50A. Here, fluid F exits perforations 46A into wellbore 12A, where packer 50A diverts fluid F into bore 35A of distributer 32A. Fluid F is discharged from distributer 32A into annulus 54A and through the exit ports 34A. In this example, sensor 67A is in communication with a discharge pressure of pump section 24A via sensor tube 65A and pressure tap 66A.

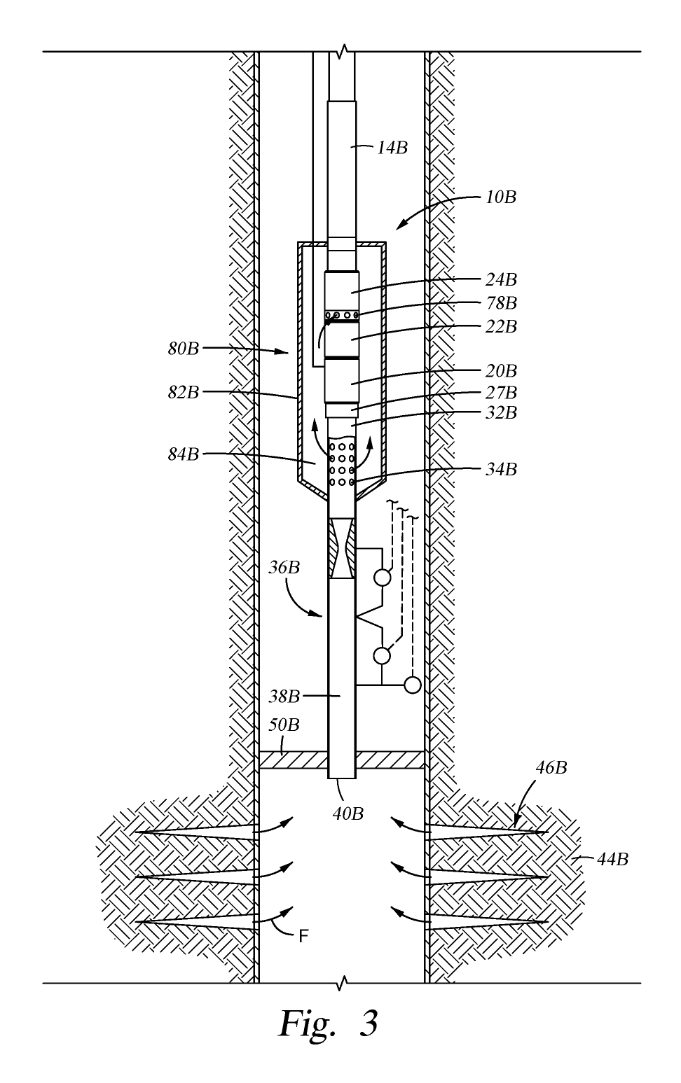

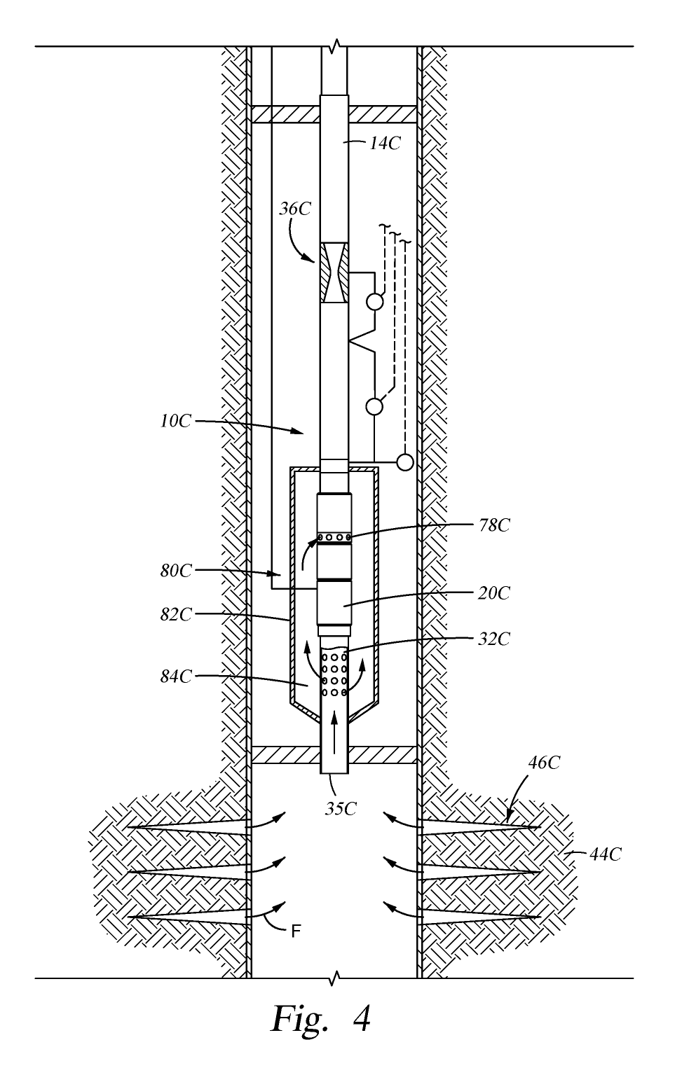

Another alternate embodiment of an ESP assembly 10B is shown in plan view in FIG. 3. In this example, a caisson 80B is provided with ESP assembly 10B in which circumscribes distributor 32B, ESP monitoring sub 27B, motor section 20B, and seal section 22B. A housing 82B is included with caisson 80B which circumscribes distributor 32B at a location spaced axially from ports 34B on a side opposite from motor section 20B. In this example, the metering assembly 36B mounts to and is in communication with an end of the distributor 32B distal from motor section 20B and conduit 38B mounts within packer 50B to divert fluid F within bore 40B for delivery through metering assembly 36B and into distributor 32B. An upper end of housing 82B sealingly couples to an outer surface of production tubing 14B to form a plenum 84B and in which the fluid exiting exit ports 34B is contained and directed up to the inlet ports 78B within pump section 24B. The use of caisson 80B therefore removes the need for upper packer 52 of FIG. 1. FIG. 4 shows in a side elevational view another alternate example of an ESP assembly 10C which incorporates the caisson 80C of FIG. 3, and has the metering assembly 36C downstream of the motor section 20C and inlet 78C.

Referring back to the example of FIG. 1, in one non limiting example of operation fluid F exits perforations 46 and enters into bore 40 of conduit 38. Pressure differential of fluid F within bore 40 is sensed by the pressure sensor 58 at pressure tap 66 and at pressure tap 70. In the embodiment shown, the linear distance between pressure taps 66, 70 is represented by symbol L₁, and the elevational or depth difference between the pressure ports 66, 70 is represented by symbol Y₁. Fluid F enters the restriction 42, where a velocity of the fluid is temporarily increased thereby reducing pressure of fluid F. The pressure differential of the fluid F between the throat 63 of the restriction 42 and pressure tap 70 is measured by pressure sensor 56 via sensor tube 60 and pressure tap 62. Moreover, pressure sensor 56 is also in communication with pressure tap 70 via sensor tube 72. The linear distance between pressure taps 70 and 62 is represented by symbol L₂. Provided in the following text are Equations 1 and 2, that in an example are expressions selectively employed for estimating a flowrate of fluid F.

ΔP₁=(g)*(Y₁)*(ρₘ)+8(f)*(L₁)*(ρₘ)*(Qₘ²)/(π²)*D⁵)) Equation 1.

Qₘ=C(((ΔP₂−(g)*(ρₘ)*(L₂))/(ρₘ))^{1/2} Equation 2.

where:

ΔP₁=difference in pressure inside conduit and between pressure taps 66, 70,

g=gravitational acceleration,

Y₁=change in elevation between the first and second pressure measurement locations,

ρₘ=density of the fluid in the conduit,

f=frictional factor of sidewall in conduit,

L₁=length in conduit between the first and second pressure measurement locations,

Qₘ=volumetric flowrate of the fluid flowing in the conduit,

D=diameter of the conduit between the first and second locations.

C=flow coefficient for the restriction,

ΔP₂=measured pressure drop between the second and third locations,

L₂=length in conduit between the second and third pressure measurement locations.

In an example, ΔP₁ is measured by the pressure sensor 58 and ΔP₂ is measured by pressure sensor 56. By obtaining the measured pressure differentials, and simultaneously solving Equation 1 and Equation 2 with the measured values of pressure, a value for the volumetric flow rate of the fluid (Qₘ) is obtained. In one example, the term of Equation 1 having gravity, height, and density represents a change in potential energy. A change in potential energy is often expressed as a static head loss. The term of Equation 1 having friction factor, piping length, volumetric flow rate, and diameter represents a pressure change due to kinematic effects, and is often expressed as a frictional loss. The volumetric flowrate of Equation 2 is based on the conservation of mass and/or energy, as the greater velocity fluid in the throat 63 (greater kinetic energy) experiences a drop in its pressure (potential energy). An advantage of this procedure is that the measurements are taken down hole and without the risk of the fluid being exposed to a pressure less than its bubble point, as compared to measurements taken at surface. In an embodiment fluid F is a mixture of oil and water, and has a density ρₘ=ρₒ (1−WC)+ρ_{w} WC, where WC=fractional water cut, ρₒ=oil density (taken from field by pressure, volume, temperature analysis or defined correlations), and ρ_{w}=water density (taken from field lab testing). Examples exist where the friction factor f is a function of Reynolds number, inlet pipe roughness, and inlet pipe diameter, and is determined from Moody's chart or empirical correlations.

In a non-limiting example of use, an action is undertaken after obtaining values of the flow and/or water fraction. Example actions include estimating a potential yield of hydrocarbons contained in the formation 44, remediating the wellbore 12 based on a ratio of the water in the total fluid being produced, changing rotational velocity of pump within pump section 24, and suspending operation of the ESP assembly 10. In some examples, an increased rotational velocity of the pump in the pump section 24 could draw in excessive water, and where the percentage of water in the fluid being pumped by the ESP assembly 10 is reduced with a reduction of pump speed. Other subsequent actions include flowmeter diagnostics if a discrepancy exists between the downhole and surface flowrate measurements. Advantages of downhole fluid flow measurements include an increase in accuracy of water cut estimates due to miscibility of water and oil when mixed over time, which in some instances affects a water cut analysis performed outside of the wellbore 12.

The present disclosure therefore is well adapted to carry out the objects and attain the ends and advantages mentioned, as well as others inherent. While embodiments of the disclosure have been given for purposes of disclosure, numerous changes exist in the details of procedures for accomplishing the desired results. These and other similar modifications will readily suggest themselves to those skilled in the art, and are intended to be encompassed within the spirit of the present disclosure and the scope of the appended claims.

What is claimed is:

1. A method of estimating a characteristic of a fluid being handled by an electrical submersible pump disposed in a wellbore, the method comprising:
directing the fluid through an axial bore in a tubular member;
obtaining a pressure of the fluid at a first location in the tubular member;
obtaining a pressure of the fluid at a second location in the tubular member that is downstream of the first location;
obtaining a pressure of the fluid at a third location in the tubular member that is downstream of the second location and is where a cross section of the bore is reduced to define a restriction;
estimating a flowrate of the fluid in the tubular member based on values of pressures at the first, second, and third locations, an expression representing a change in static head, an expression representing pressure losses due to friction between the first and second locations, and an expression representing fluid flowrate based on conservation of mass and/or energy of the fluid flowing across the restriction.

2. The method of claim 1, where the restriction comprises a venturi meter.

3. The method of claim 1, where the expression representing the change in static head comprises (g)*(Y₁)*(ρₘ), and where g=gravitational acceleration, Y₁=a change in elevation between the first and second locations, and ρₘ=density of the fluid in the tubular member.

4. The method of claim 1, where the expression representing pressure losses due to friction between the first and second locations comprises 8f*(L₁)*(ρₘ)*(Qₘ²)/((π²)*D⁵)), and where f=frictional factor, L₁=a distance between the first and second locations, ρₘ=density of the fluid in the tubular member, Qₘ=the flowrate of the fluid flowing in the tubular member, D=diameter of the tubular between the first and second locations.

5. The method of claim 1, where the expression representing fluid flowrate based on conservation of energy of the fluid flowing across the restriction comprises Qₘ=C(((ΔP−(g)*(ρₘ)*(L))/(ρₘ))^{1/2}, and where Qₘ=the flowrate of the fluid flowing in the tubular member, C=a coefficient for the restriction, ΔP=measured pressure drop between the second and third locations, g=gravitational acceleration, ρₘ=density of the fluid in the tubular member, L₂=distance between the second and third locations.

6. The method of claim 1, further comprising estimating oil and water fractions of the fluid.

7. The method of claim 1, where the tubular is disposed adjacent the electrical submersible pump.

8. The method of claim 1, where the restriction comprises a venturi meter having a length that ranges from about 27 to about 38 times a diameter of the bore.

9. A method of estimating a characteristic of a fluid being handled by an electrical submersible pump disposed in a wellbore, the method comprising:
obtaining a first pressure of the fluid at a first location in a tubular member in which the fluid is flowing;
obtaining a second pressure of the fluid at a second location in the tubular member and that is downstream of the first location;
obtaining a third pressure of the fluid as the fluid flows across a restriction; and
estimating a flowrate of the fluid based on changes in static head between the first and second locations, and a change in pressure between the second and third locations.

10. The method of claim 9, where the restriction comprises a throat of a venturi meter and the second location is at an entrance to the venturi meter.

11. The method of claim 9, where the fluid comprises a mixture of water and oil, and where a density of the fluid is estimated in conjunction with the step of estimating the flowrate.

12. The method of claim 9, further comprising adjusting an operating parameter of the electrical submersible pump based on the estimated flowrate.

13. An electrical submersible pumping system disposed in a wellbore comprising:
a pump section having a pump inlet;
a motor section for driving the pump section;
a seal section coupled with the motor section;
a meter that estimates a characteristic of a fluid handled by the electrical submersible pump and that comprises;
a tubular member having a bore extending axially within;
a restriction in a portion of the bore;
a first pressure tap in the tubular member;
a second pressure tap in the tubular member that is downstream of the first pressure tap and disposed at an entrance to the restriction;
a third pressure tap in the tubular member and disposed at the restriction; and
a controller in communication with sensors that are in communication with the first, second, third pressure taps, the controller configured to estimate a flowrate of the fluid based on pressures measured at the pressure taps.

14. The system of claim 13, where the restriction comprises a throat portion of a venturi meter.

15. The system of claim 13, further comprising a caisson circumscribing the motor section, seal section, and pump section to define a plenum space.

16. The system of claim 15, where fluid flows into the plenum space through a tubular element that extends through a portion of the caisson.

17. The system of claim 13, where communication between the controller and sensors occurs along a power cable that connects to the motor section.

18. The system of claim 13, where the meter is disposed upstream of the pump inlet.

19. The system of claim 13, where the meter is disposed downstream of the pump inlet.

20. The system of claim 13, further comprising an ESP monitoring sub, and where the controller is disposed at a location selected from the group consisting of on surface and in the ESP monitoring sub.

21. The system of claim 13, further comprising an ESP monitoring sub, and where the controller is disposed in the ESP monitoring sub, and where data from the sensors is transmitted to surface along a power cable.
